(19) United States
(12) Patent Application Publication
(10) Pub. No.: US 2016/0063128 A1
(43) Pub. Date: Mar. 3, 2016

(54) CODE SOURCING ON PRODUCTS TO ACCESS SUPPLEMENTAL INFORMATION VALUE

(71) Applicant: David Swerdlick, Plymouth, MN (US)

(72) Inventor: David Swerdlick, Plymouth, MN (US)

(21) Appl. No.: 14/841,595

(22) Filed: Aug. 31, 2015

Related U.S. Application Data
(60) Provisional application No. 62/044,280, filed on Aug. 31, 2014.

(51) Int. Cl. G06F 17/30; H04M 1/725

(52) U.S. Cl. CPC G06F 17/30879; H04M 1/72527; H04M 1/72544

(57) ABSTRACT

A system and method for using identification codes found on ordinary articles of commerce to access remote computers on a network. In accordance with one embodiment of the invention, a computer is provided having a database that relates Uniform Product Code (“UPC”) numbers, Quick Response Codes (“QR”), and other technologies to Internet network addresses (or “URLs”). To access an Internet resource relating to a particular product, a user enters the product's UPC symbol manually, by swiping a bar code reader over the UPC symbol, scanning the products code, connecting via Bluetooth, RFID, or via other suitable input means. The database retrieves the URL corresponding to the UPC code. This location information is then used to access the desired resource.

### RELATED APPLICATION DATA

The present application claims priority from U.S. Provisional Patent Application Ser. No. 62/044,280, filed 31 Aug. 2014.

### BACKGROUND OF THE INVENTION

1. Field of the Invention

This invention relates to computer communications generally, and more specifically to techniques for giving users convenient access and responses from that access to information available through Internet access.

2. Background of the Invention

A computer network is a set of computers (or “hosts”), which are able to communicate electronically. In logical terms, the network can be viewed as a set of nodes or “sites”, with each computer on the network being home for one or more nodes. Generally speaking, each host is assigned a numeric address, which the network uses to route information to that particular host. To facilitate human use of networks, addresses are often given alphanumeric codes (or “mnemonics”), which are easier for people to remember. For example, the numeric address 213.87.4329.44 may be assigned the mnemonic “product.com.”

At the present time, the world's most important network is the Internet. The Internet is a worldwide collection of computer resources, connected together in network fashion by a series of communication protocols known as TCP/IP. Many sites on the Internet can be accessed in accordance with popular standard protocols or formats such as and “SOAP”, and Hypertext Transport Protocol (“HTTP”). These sites act as remote servers, providing information to users' computers (or “clients”) in accordance with a particular format or protocol. The client system (often an individual's personal computer) must have the necessary software to handle the server's particular protocol.

For example, sites set up in accordance with HTTP are nicked-named “Websites”. If a user wants to access a Website, they must have a tablet, smartphone, computer, or similar digital device connected to the Internet and equipped with software for communicating in accordance with the SPDY or HTTP protocol. Such software is often called a “browser,” because it allows users to browse (or, in the parlance of the enthusiasts, “surf”) from Web site to Web site, much the way one might browse through a library. This process is facilitated by the fact that most Web sites have hypertext links to other Web sites, which the user can activate by clicking a mouse on a highlighted portion of the screen.

Typical browser software also maintains a list of sites the user has visited, which the user can recall using commands such as “back” and “forward.” These commands, coupled with the hypertext links between Web sites, give users the sensation of “navigating” through a seemingly infinite realm of information, which is popularly referred to as “cyberspace” or the “World Wide Web.”

Users can also specify a Web site by manually typing in the site's location as a Uniform Resource Locator (“URL”). The URL specifies the precise location of a particular resource, and has three fields: <resource type><domain name><path>Domain name, as explained above, is the alphanumeric network address of the host on which a particular resource resides. The “path” is the specific directory and file on the host where a resource is stored. A typical URL is http://ngo.cc.utminn.edu/neural/cwsapps.html.

For example, the command “Go<URL>” would cause browser software to request the information residing at the site specified by the URL. This is called “pointing” the browser to the desired Web site. The Web server at the designated URL processes the browser's request by transferring a copy of the file specified by the URL to the user's local host computer. The transferred file includes embedded commands in the hypertext markup language (“HTML”), which cause the client's browser software to display and handle the transferred file in a desired manner.

Cyberspace is not limited to the World Wide Web or the Internet. Massive amounts of information are also available on networks maintained by on-line service providers under the service marks Xfinity, and CenturyLink, DirectTV for example. Users typically access these on-line services via telephone modem connection. To the end user, these networks appear to be a series of sites or locations or “rooms” offering various types of information. The addresses for these locations are assigned by the on-line service providers. Navigation among these locations is handled by proprietary client software, which runs on the user's personal computer.

Many users learn of resources on the Internet or a proprietary on-line service through magazine articles and advertisements. These articles and advertisements include the necessary URL or other network address to access the desired site. Many publications compile lists of sites they deem particularly worthwhile. When a user sees a listing for a site which looks interesting, he can manually enter the published URL or other mnemonic address into his browser or other software, and access the site.

Sometimes published computer addresses—whether URLs or otherwise—can be difficult for people to use because they have to be tediously and accurately entered into their computers. A good example of an address which may be difficult to enter is the University of Minnesota address cited above. The problem is particularly acute for persons with a visual or physical disability.

Another problem using the Internet, we realized, is that many users have trouble even finding URLs or other network addresses for desired sites such as Web pages. Accordingly, Web site sponsors publish their Web site URLs in print advertising and on packaging. The difficulty with this approach, however, is that the URLs are still long, and cumbersome to remember and enter into a computer.

Published U.S. Patent Application Document No. 20120233174 and its identified copending U.S. Patent Application proposed to resolve these problems by allowing people to access published locations without having to manually enter the published address. In accordance with one embodiment of the invention, the mnemonic address or verbal description of a network location is published along with the location's numeric address in bar code format. The user's computer is equipped with a bar code reader and browser software. The bar code reader is suitably interfaced to the computer's browser software to allow bar code input to be accepted as address information. When the user sees an interesting published address, he scans the associated bar code using the bar code reader, thereby loading the desired numeric address into the browser. The browser then accesses the Web or other site corresponding to that numeric address.

### SUMMARY OF THE INVENTION

The present invention offers a better way for consumers and others to access resources on remote computers, particularly at Web sites. In accordance with the invention, the dissemination and entry of network addresses is accomplished by means of existing identification standards (e.g., bar codes and more particularly QR codes, RFID, and Bluetooth which can be provided on blankets, toys and especially plush toys in conjunction with a centralized database of network locations which respond to that QR code being read, and transmitted into the internet. A user can also gain access to the content by connecting a Bluetooth enabled device with another, where one transmits and one receives the content, or activated through RFID technologies, where a digital device is used to activate and view content.

### BRIEF DESCRIPTION OF THE DRAWINGS

FIG. 1 is a block diagram of a computerized system for interfacing with a computer network in accordance with the invention.

FIG. 2 is a frontal view of a plush toy having a fictitious QR symbol available thereon.

FIG. 3 is a side view of a plush toy with a QR code on its side.

### DETAILED DESCRIPTION OF THE INVENTION

### 1. Overview

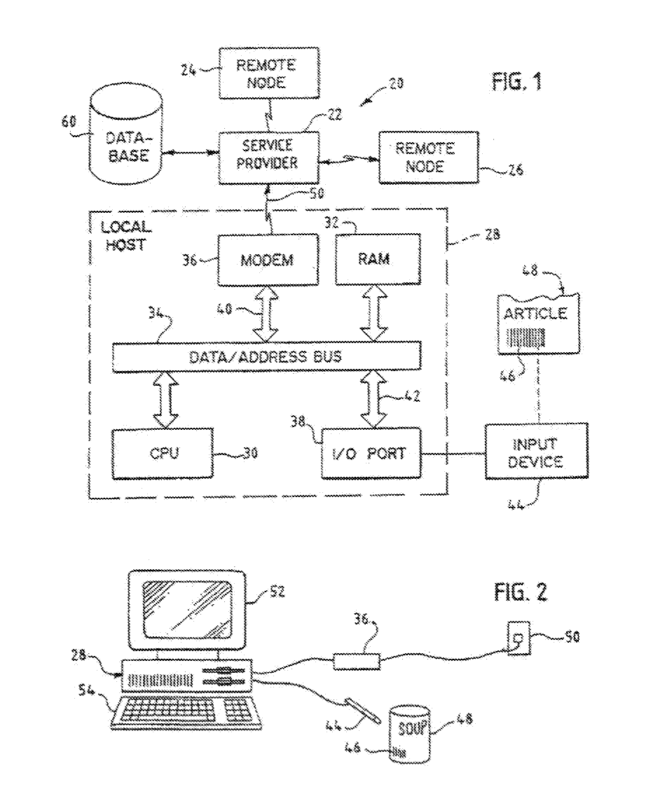

FIG. 1 is a block diagram illustrating one application of the invention, namely the use of an ordinary article of commerce to access sites on the Internet's World Wide Web. As explained below, this embodiment of the invention allows a person who desires Internet resources concerning a particular product to access those resources using the product's UPC symbol. The data encoded on the UPC symbol can be entered manually or (for greater convenience) using a bar code reader.

Referring to FIG. 1, the Internet 20, illustrated here in generalized format, includes a service provider 22 and two remote nodes 24 and 26. In this case, service provider 22 is a local Internet access provider. Service provider could also be an online service provider, such as Xfinity, CenturyLink, and DirectTVAmerica, In such cases, local host 28 need not be on Internet 20—that is, need not have a network address.

An end-user (not shown) accesses Internet 20 using local host 28, which in this case is an IBM compatible personal computer including a CPU 30, a random access memory 32 and an address/data bus 34 by operatively connecting CPU 30 and memory 32. Unless otherwise specified, the term “memory” herein includes any storage device, including RAM, tape or disk drives (or collections or networks of tapes or disk drives), and any other device for storing information. A modem 36 and I/O port 38 are attached to bus 34 by suitable interfaces 40 and 42, respectively. An input device 44 is connected to bus 34 via I/O port 38. Input device 44 is a commercially available wand-style bar code reader reads a QR variant of a Uniform Product Code (“UPC”) bar code symbol 46 affixed to an article of commerce 48. Alternatively, input device 44 could be a card reader, optical character or voice recognition system, touch screen, scanner, pen, keyboard or other known input device.

Local host computer 28 need not be a personal computer, and could for example be a mainframe or minicomputer having a terminal by which the user could enter and receive data. In that arrangement, input device 44 would be attached to the terminal.

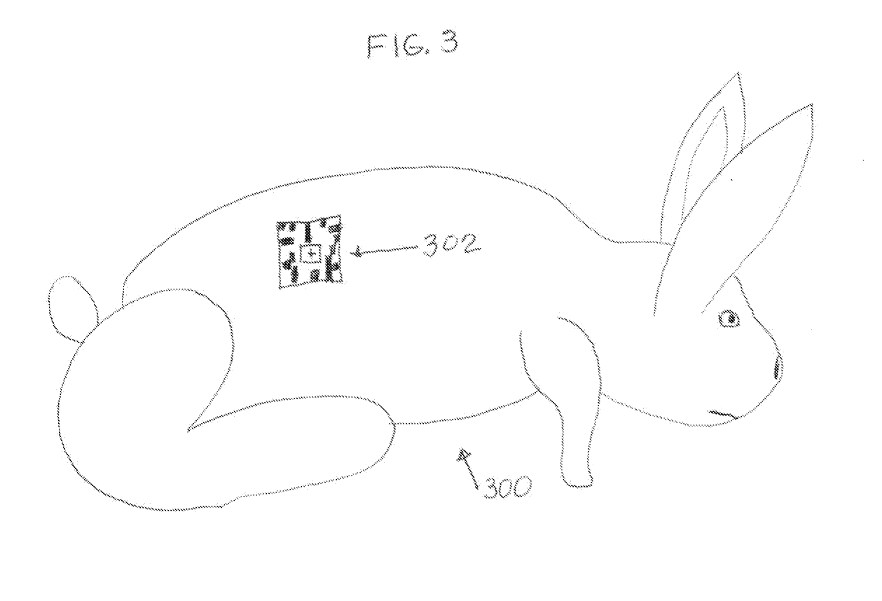

Modem 36 is adopted for electronic communication via a suitable telephone link 50 with service provider 22. Computer 28 functions as an Internet host because it is connected to service provider 22 using Point to Point Protocol (“PPP”) via telephone link 50. Other telecommunications channels may be used, such as ISDN or a connection which incorporates a third party intermediary network such as TymNet.sup.sm. Alternatively, local host 28 could be connected directly to Internet 20, as is likely to be the case where local host 28 is a larger computer, such as mainframe. FIG. 2 offers a perspective view of local host 28 and article of commerce 48 and also illustrates a CRT monitor 52 and keyboard 54 suitably coupled to bus 34.

In this illustration, local host 28 is used to access Internet resources (or “Web sites”) on remote nodes 24 and 26, which are available using the HTTP protocol. HTTP uses a client-server architecture, with remote nodes 24 and 26 acting as servers, and local host 28 acting as a client. Local host is equipped with Netscape Navigator brand Web browser software which enables it to function as an HTTP client.

Remote nodes 24 and 26 have pre-assigned network locations (or “domain names”), and desired resources (such as a particular Web site) are located in specific directories and files (or “paths”) resident on a remote nodes 26 and 28. The precise locations of those resources are specified using URL, which, as explained above, includes three fields: <resource type><domain name><path>. To access resources of a particular remote node 24 or 26, local host 28 requests those resources from Internet 20 using the appropriate URL. Thus, the URL functions as a more precise kind of network address than a domain name.

The URL required is often supplied by the user. Users learn about the existence of a desired resource (and its corresponding ULR) through a variety of means, including publication in a printed advertisement. In current practice, the URL acquired from a printed source must be entered using a keyboard. As explained above, this can be tedious. Moreover, in many cases, users may have trouble finding references to desired Web pages.

### 2. Article of Commerce

In accordance with the invention, access to desired resources on remote nodes 24 and 26 is achieved using a limited scope of articles of commerce 48 as the returned or directed to information is unique to that item and the content returned is also unique and thematically related within the scope of properties of the article of commerce. The term “article of commerce” includes tangible products that may be sold or moved through commerce, particularly such as consumer blankets, toys, and plush toys. Article 48 bears a standard QR type code symbol or indicia 46. Symbol 46 may be affixed to article 48 in any suitable manner, including printing directly on the article or its packaging, or applied as labels or tags attached or otherwise affixed to the article. In accordance with QR standards, symbol 46 encodes a multiple of arranged digital (black or white) pixels and generally a fiducial for focusing or ordering of data visually received from the QR symbol.

QR symbol 46 provides a machine-readable number/data set/identification code that uniquely identifies a particular product or particular type of product and its manufacturer. This is useful at the retail point-of-sale, where purchase of a particular item is recorded by scanning the item's QR symbol.

The numbering systems used by QR systems share at least three characteristics. First, for purposes of this invention, the identification numbers may be assigned in accordance with an “extrinsic” standard. By extrinsic, it is meant that the assignment of numbers is made a by a company, business enterprise, individual, group or association for the purpose of identifying articles of commerce. It is likely that new types of identification numbers will arise in the future, as will new organizations for assigning and administering those numbers, and the present invention contemplates use of both existing and future extrinsic identification numbers and formats.

Second, the identification numbers may have recognized significance as numbers identifying one or more articles of commerce. The level of recognition may be among the general public, or a defined subset, such as a particular industry or occupation.

Third, the identification numbers may be encoded in a standard, machine readable format—namely, QR codes. Other machine readable formats may also be used for this purpose, including magnetic stripes or optical character recognition (“OCR”), and the present invention could be practiced with product identification numbers encoded in those formats as well.

### 3. QR Code Basics

QR code (abbreviated from Quick Response Code) is the trademark for a type of matrix barcode (or two-dimensional barcode) first designed for the automotive industry in Japan. A barcode is a machine-readable optical label that contains information about the item to which it is attached. A QR code uses four standardized encoding modes (numeric, alphanumeric, byte/binary, and kanji) to efficiently store data; extensions may also be used.

The QR Code system has become popular outside the automotive industry due to its fast readability and greater storage capacity compared to standard UPC barcodes. Applications include product tracking, item identification, time tracking, document management, general marketing, and much more.

A QR code consists of black modules (square dots) arranged in a square grid on a white background, which can be read by an imaging device (such as a camera) and processed using Reed-Solomon error correction until the image can be appropriately interpreted. The required data are then extracted from patterns present in both horizontal and vertical components of the image

### Mobile Operating Systems

QR codes can be used in Google's Android™, Blackerry™ OS, Nokia Symbian Belle™, Apple IOS devices (iPhone/iPod/iPad), Microsoft Windows™ Phone, Google Goggles, 3rd party barcode scanners, and the Nintendo 3DS. These devices support URL redirection, which allows QR codes to send metadata to existing applications on the device. mbarcode is a QR code reader for the Maemo operating system. In Apple's iOS and Google's Android, a QR code reader is not natively included, but many paid and free apps are available with both the ability to scan the codes and hard-link to an external URL. Blackberry 10 devices have a native QR reader as well as several third party readers. Windows Phone 7.5 is able to scan QR codes through the Bing search app's feature called Bing Vision.

In accordance with the invention, service provider 22 includes a relational database that includes records, which are accessible using a suitable database management system software. Each record of the database contains multiple fields (e.g., four fields). The fields may contain a QR product identification number. The field holds a URL suitable for locating a resource on the Internet. Depending on the application, other network addresses—either numeric or mnemonic, physical or virtual—may be used. The fields hold a narrative description of the resource addressed in the fields. This particular arrangement of fields is but one illustration of how the invention may be practiced. For example, additional fields could be provided, or the QR product identification number could be held in a single field.

Each record of databases associates a QR product identification number (contained in fields) with a particular Internet URL and narrative description (contained in the fields, respectively). The association is based on selected criteria. In this case, the criteria is the existence of a Web resource sponsored by the manufacturer of the product identified by the QR number in the fields. (If no such resource exists, then the particular product identifier can be omitted from the database). Other criteria can be used. For example, the association could be based on the existence of a Web site simply referring to or relating to the product.

As stated, fields contain a UPC product identification number. A field contains the at least first (e.g., four or five) digits of the product identification number. As explained above, these digits uniquely identify the product's manufacturer. A field contains additional second (e.g., four or five) digits of the product identification number. These digits identify the manufacturer's particular product. In some cases, a manufacturer may have many products and only one Web site or other Internet resource. In that case, a next field may be left blank. When this next is left blank, the database associates the Web resource indicated in an further field with any product identification number whose first (e.g., four of five) digits match the manufacturer number specified in an earlier field.

The database itself is accessible via service provider 22, which is equipped with Web server software such as provided by Comcast, Netscape Communications, Inc. The server software provides access to an HTML document (the “Query Page”) resident on service provider 22 at a predetermined URL. The Query Page, when displayed on a CRT by local host 28 using a forms-capable browser allows the user to enter a query in the form of a UPC product identification number. Alternatively, the database could be resident on local host 28 or another remote computer 24 or 26. The Web server at service provider 22 may have a predetermined URL location. Browser software resident in local host computer 28 may be configured to automatically request that predetermined URL location when the browser software is initially loaded.

The database 60 may be incorporated with a database or search engine of Web sites or other Internet resources (such as the Google, Yahoo or Bing databases). In that case, the Query Page may give the user the option of entering a UPC number or an alternative search term, such as a portion of the URL or the topic to which the desired resource pertains.

Also, the database may be divided into one or more tables, which may be distributed over more than one computer. For example, a first table may contain records associating UPC numbers with names of products or manufacturers. A second table associates products and/or manufacturer names with Internet addresses. Thus, the process of using the UPC number to locate a network address may involve one or more steps. For example, the database might determine the name of a product corresponding to a UPC number using a first table, and then determine network addresses corresponding to that product name using a second table. Even though multiple steps are involved, the UPC number is still “associated” in computer memory with the network address for purposes of the invention.

### 4. Operation of the Invention

If a user is interested in Internet resources concerning a particular type of product, especially the services identified herein upon purchase of the product, in accordance with the invention, the user can access those resources by taking an ordinary specimen of the product—a can of soup for example—and scanning all or part of the product's QR identifier product identification number. The database uses the entered product identification number to lookup the associated URL, which is returned to the user in the form of a feed from the central server.

When the product has not yet been purchased, samples only of the provided internet service or data may be provided. For example, if the product is a plush toy of a uniquely identifiable character (e.g., Warner Brothers “Marvin the Martian”), the sample response fed back to the screening device (which may be store located to establish the product has not yet been sold) might be a cartoon image of Marvin the Martian stating to the viewer, “Hello Earth friend. I hope you are well. Buy me so we can speak more.”

Once the product has been purchased and the QR is scanned and transmitted by a personal device, more complete fed activities can be provided. It is possible to allow full access at the source of the product (e.g., the store), as a potential customer is not likely to exhaust the potential material that can be fed to an ultimate purchaser/user.

Identical or related objects may be provided with different levels (and costs) of available material. For example, a base product of a plush Marvin the Martian toy may access cartoons only. A higher level QR code may also enable interaction with a canned interactive system that responds to specific words or actions (movement of the toy in specific manners such as pressure under the arms (indicating tickling), pressure around the back (indicating hugging), etc. Other potential activities may be differentiated by levels of function/cost identified and accessed through the QR code to the database.

Other Networks and Protocols. While the present invention is illustrated with respect to a system for accessing the Internet's World Wide Web, it could be practiced using other Internet protocols (such as Gopher) or other types of wide area networks and systems, including those offered by “on-line service” providers such as Xfinity™, or CenturyLink™ services.

In those cases, the database could be resident on the on-line service provider's computer. The network address information contained in the database could be either Internet URLs, or locations within the on-line service provider's environment. In this case, the protocol used to communicate between local host 28 and service provider 22 need not be HTTP or other Internet protocol. However, service provider 22 can provide a gateway to Internet 20, and access to a desired network location on the Internet can be made using a URL retrieved from the database.

Controlled Access. The database need not be publicly accessible. Access to database can be limited either by placing the database on a proprietary network, or, if placed on an open network, using a password or digital signature system to permit access only to authorized persons. Also, records may be selectively accessible. For example, each record can contain an additional field indicating whether the URL contained in a field points to network location containing material inappropriate for children. In that case, the database can be programmed to return URL only if the user has supplied a proper password.

Automatic Jumping to Desired Location. In the disclosed embodiment, the URL associated with a selected UPC product identification code is returned to the end user in an accessible data source. The user can then communicate with specific requests or demands by conventional user data input or commands.

FIG. 3 is a side view of a plush toy 300 with a QR code 302 on its side.

Unless use of the at least second segment is free of charge, the end user may also be charged for the selected use of an annotation, on a per segment basis. Alternatively, this step is combined with a verification of a relevant subscription (e.g., store membership, club membership, or other membership, which verifies the end user entitlement to access certain annotations at a certain rate. In such a case, the charging/verification may instead be executed prior to receipt of the second segment content. Alternatively, a charging system may be based on contributions and consumption of segments, such that a counter associated with a first end user is increased each time a segment is added to an electronic content by the first end user, i.e. the counter is increased for each produced segment (e.g., serial sequences. For example, the toy may be a Winnie the Pooh doll, and scanning the QR code on the doll accesses at least a first segment of a Winnie the Pooh video story. This can provide local entertainment value to the ultimate intended owner of the toy, such as a child in the store. By withholding broadcast of later segments of the story until the toy is purchased and the code to further transmission of the later segments enabled, an incentive to purchase the toy is created. It is possible to provide the code for later access where there is payment involved in exercising the code to obtain access to later segments through the user device or a separate user device (e.g., smart TV, pad, tablet, laptop computer, floor model computer, cable-connected TV and the like) A method executed on the annotation server described above, allowing an end user to enrich the media content of an electronic segment having thematic relationship to the blanket or toy is also enabled. This process may be referred to as a content producing process. As already mentioned above, as a prerequisite for this embodiment, the end user has started with initiating a service which enables him, not only to render user original media content of the selected electronic content in a conventional way, but also to add or access segments to the rendered media content, at desired locations.

The present technology further includes a method of a user of a blanket or toy product having a QR code symbol on an exterior surface, the QR code symbol configured to interact with a distal server providing animated and/or audio content upon demand including:
a user scanning data from the QR code symbol on the blanket or toy product with an optical reader device having a user viewable display device,
the optical reader transmitting scanned data from the scanned QR code symbol over the internet to the distal server;
the distal server transmitting enabled animated and/or audio content to the reader and display device; and
the display device displaying the enabled animated and/or audio content.

The blanket or toy has a user viewable thematic character displayed on the blanket or toy, and the animated and/or audio content transmitted from the server is visually and/or audibly provided on the optical reader device, and the animated and/or audio content transmitted from the server comprises a first segment of a complete recording stored on the server. The animated and/or audio content transmitted from the server may be accompanied by a code transmission that can be entered into any second wi-fi enabled video and/or audio device, and that transmission of the code transmission from the second wi-fi enabled video and/or audio device to the distal server will enable transmission of at least a second segment of the complete recording stored on the server. The method may be practiced where the second video or audio device is selected from the group consisting of a smart phone, a computer with a display screen, a television with a wi-fi connected computer therein, a cable-connected television, or wi-fi connected tablet or pad. The user scanning device may be a cell phone, wi-fi connected pad or wi-fi connected tablet or store provided hand-scanning device.

What is claimed:

1. A method of a user of a blanket or toy product having a QR code symbol on an exterior surface, the QR code symbol configured to interact with a distal server providing animated and/or audio content upon demand comprising:
a user scanning data from the QR code symbol on the blanket or toy product with an optical reader device having a user viewable display device,
the optical reader transmitting scanned data from the scanned QR code symbol over the internet to the distal server;
the distal server transmitting enabled animated and/or audio content to the reader and display device; and
the display device displaying the enabled animated and/or audio content.

2. The method of claim 1 wherein the blanket or toy has a user viewable thematic character displayed on the blanket or toy, and the animated and/or audio content transmitted from the server is visually and/or audibly provided on the optical reader device.

3. The method of claim 2 wherein the animated and/or audio content transmitted from the server comprises a first segment of a complete recording stored on the server.

4. The method of claim 2 wherein the animated and/or audio content transmitted from the server is accompanied by a code transmission that can be entered into any second wi-fi enabled video and/or audio device, and that transmission of the code transmission from the second wi-fi enabled video and/or audio device to the distal server will enable transmission of at least a second segment of the complete recording stored on the server.

5. The method of claim 4 wherein the second video or audio device is selected from the group consisting of a smart phone, a computer with a display screen, a television with a wi-fi connected computer therein, a cable-connected television, or wi-fi connected tablet or pad.

6. The user scanning device of claim 1 comprising a cell phone, wi-fi connected pad or wi-fi connected tablet.

7. The user scanning device of claim 2 comprising a cell phone, wi-fi connected pad or wi-fi connected tablet.

8. The user scanning device of claim 3 comprising a cell phone, wi-fi connected pad or wi-fi connected tablet.

9. The user scanning device of claim 4 comprising a cell phone, wi-fi connected pad or wi-fi connected tablet.

10. The user scanning device of claim 5 comprising a cell phone, wi-fi connected pad or wi-fi connected tablet.

11. A system for providing entertainment content to a user, the system comprising:
a blanket or toy having a QR code symbol on an exterior surface, the QR code symbol configured to interact with a distal server providing animated and/or audio content upon demand;
a user-controlled optical reader having a wireless transmitting capability configured to communicate with the distal server;
the QR code symbol configured to enable a wireless communication link between the user controlled optical reader and the server;
the server configured to transmit to the user-controlled animated and/or audio content upon receipt of the QR code symbol from the user controlled optical reader and scanner; and
the user controlled optical reader having audio and/or video enabling components that can play the audio and/or video content.

12. The system of claim 11 wherein the blanket or toy has a user viewable thematic character displayed on the blanket or toy, and the animated and/or audio content transmitted from the server is visually and/or audibly provided on the optical reader device.
